(19) United States
(12) Patent Application Publication
(10) Pub. No.: US 2012/0017447 A1
(43) Pub. Date: Jan. 26, 2012

(54) HAND-HELD POWER TOOL FOR PRUNING AND CUTTING VEGETATION AND A METHOD FOR REPLACING BLADES THEREOF

(75) Inventors: Fangjie Nie, Nanjing (CN); Toshinari Yamaoka, Nanjing (CN); Haishen Xu, Nanjing (CN); Li Li, Nanjing (CN)

(73) Assignee: CHERVON (HK) LIMITED, Wanchai (HK)

(21) Appl. No.: 13/189,694

(22) Filed: Jul. 25, 2011

(30) Foreign Application Priority Data
Jul. 26, 2010 (CN) 201010223323.9

(51) Int. Cl. A01G 3/053; B23P 6/00; B26B 15/00

(52) U.S. Cl. 30/228; 30/277.4; 29/402.08

(57) ABSTRACT

A hand-held power tool for pruning and cutting vegetation and a method for replacing blades thereof. The hand-held power tool has a main body and a work head detachably mounted on the main body. The main body has a housing, a motor placed in the housing, and a first gear transmissively connected with the motor. The work head has a blade assembly and a second gear. The second gear engages with the first gear and is provided with a eccentric member connected with the blade assembly. By arranging one portion of the transmission mechanism on the work head, especially the second gear used for providing the eccentrically rotary output on the work head, the transmission mechanism is directly connected with the blade assembly. When the work head needs to be mounted on the main body, it only needs the second gear to be placed on the mandrel arranged on the main body where it will engage with the first gear. This avoids the need to align and mate the eccentric member arranged on the second gear with the upper and lower blades one by one thereby providing an assembly process that is simple and time-saving while providing a connection that is reliable.

### RELATED APPLICATION DATA

This application claims the benefit of CN 201010223323.9, filed on Jul. 26, 2010, the disclosure of which is incorporated herein by reference in its entirety.

### BACKGROUND

The subject application generally relates to gardening power tools and, more particularly, to a hand-held power tool for pruning and cutting vegetation and a method for replacing blades thereof.

A hand-held power tool for pruning and cutting vegetation usually comprises a main body and a work head arranged on one end of the main body. A motor and a transmission mechanism are arranged in the main body. The work head comprises a set of blades, namely, an upper blade and a lower blade. Rotary output of the motor is converted into an eccentrically rotary output via the transmission mechanism and the eccentrically rotary output drives the upper blade and the lower blade to make a reciprocating linear cutting movement between the blades.

Due to the upper blade and the lower blade being assembled together, when the blades need to be replaced after being worn out, the upper blade and the lower blade are usually replaced as a whole. However, when the blades are being replaced it is very difficult to ensure that the transmission mechanism will properly mate with the upper and lower blades. Thus, replacing the blades of known devices is a very troublesome procedure since it often requires that the work head be taken apart.

### SUMMARY

The following describes a hand-held power tool for pruning and cutting vegetation and a method for replacing the blades thereof wherein worn blades in the hand-held power tool can be quickly and easily replaced. To this end, the hand-held power tool has a main body and a work head detachably mounted on the main body. The main body has a housing, a motor placed in the housing, and a first gear transmissively connected with the motor. The work head has a blade assembly and a second gear and the second gear engages with the first gear.

In certain embodiments, the second gear may be provided with a eccentric member connected with the blade assembly and/or the second gear may be detachably mounted on a mandrel on the main body. Additionally, the eccentric member may include a first eccentric block and a second eccentric block sequentially connected to the second gear with the blade assembly having a first blade and a second blade. The first eccentric block would be mated with a first slotted hole on the first blade and the second eccentric block would be mated with a second slotted hole on the second blade. A stop plate would also be arranged between the first eccentric block and the second eccentric block would have a diameter greater than the diameter of the first eccentric block. The circle center of the first eccentric block and the circle center of the second eccentric block may also be symmetrically arranged on both sides of the axis of the second gear.

The work head may further include a bottom plate and a support plate fixedly connected with the bottom plate where the blade assembly is movably connected to the support plate.

The blade assembly may also be provided with a reinforcement member thereon.

To replace the blades of such a hand-held power tool for pruning and cutting vegetation, a user need only mount the second gear onto the mandrel and engage the second gear with the first gear and then fixedly connect the work head to the main body.

As will become apparent, the subject device has the advantage of being arranged in a manner wherein a blade replacement operation is simple and saves time while providing a connection that is reliable.

### BRIEF DESCRIPTION OF THE DRAWINGS

The subject device will be described with reference to the following drawings wherein:

FIG. 1 is a three-dimensional view of a work head of a hand-held power tool for pruning and cutting vegetation constructed according to a preferred embodiment;

FIG. 2 is a partial three-dimensional view of a main body of the hand-held power tool for pruning and cutting vegetation; and

FIG. 3 is an exploded view of the work head of the hand-held power tool for pruning and cutting vegetation.

### DETAILED DESCRIPTION

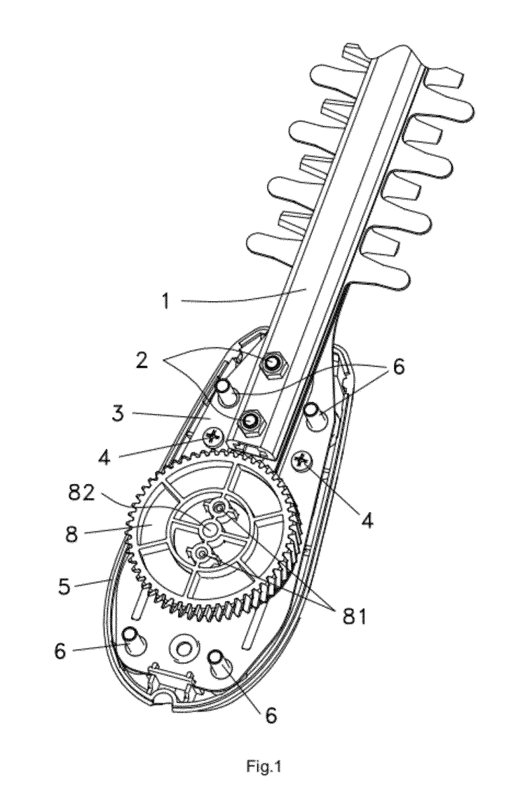

FIG. 1 illustrates a three-dimensional view of a work head of a hand-held power tool for pruning and cutting vegetation which is constructed according to a preferred embodiment. The work head comprises a blade assembly 1 movably assembled on a support plate 3 by a fastening bolt 2. The support plate 3 is fixed on a plastic bottom plate 5 by a fastening screw 4. The rear end of the blade assembly 1 is connected with a second gear 8.

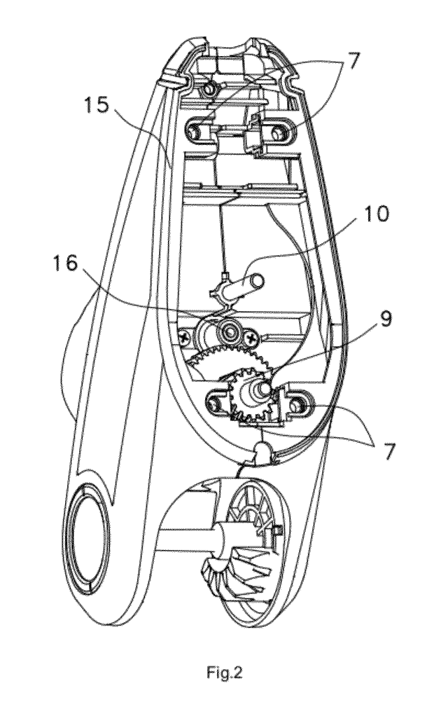

FIG. 2 illustrates a partial three-dimensional view of a main body of the hand-held power tool for pruning and cutting vegetation according to one preferred embodiment. The main body comprises a housing 15 and a motor and a transmission mechanism arranged in the housing 15. The motor is transmissively connected to a first gear 9 via the rotary output shaft 16 thereof. The first gear 9 is a duplex gear for decelerating and transferring force, of which a big straight-tooth portion on the rear end is engaged with a straight-tooth cylindrical gear fixed on the output shaft 16 of the motor to form a one-stage reduction and a small skewed tooth portion on the front end is engaged with the second gear 8 to form a two-stage reduction. The second gear 8 is a big skewed cylindrical gear.

To mount the work head onto the main body, first, the second gear 8 is placed onto a mandrel 10 arranged in the main body 1, and at this moment the second gear 8 should be engaged with the small skewed tooth portion on the front end of the first gear 9, then, the fastening bolt 6 is passed through the holes provided on the bottom plate and the support plate and it is screwed into the bolt hole 7 arranged on the housing 15, thus, the blade assembly 1, the second gear 8, the support plate 3 and the bottom plate 5 as a whole of the work head are mounted onto the main body. The mounting is simple and the connection is firm.

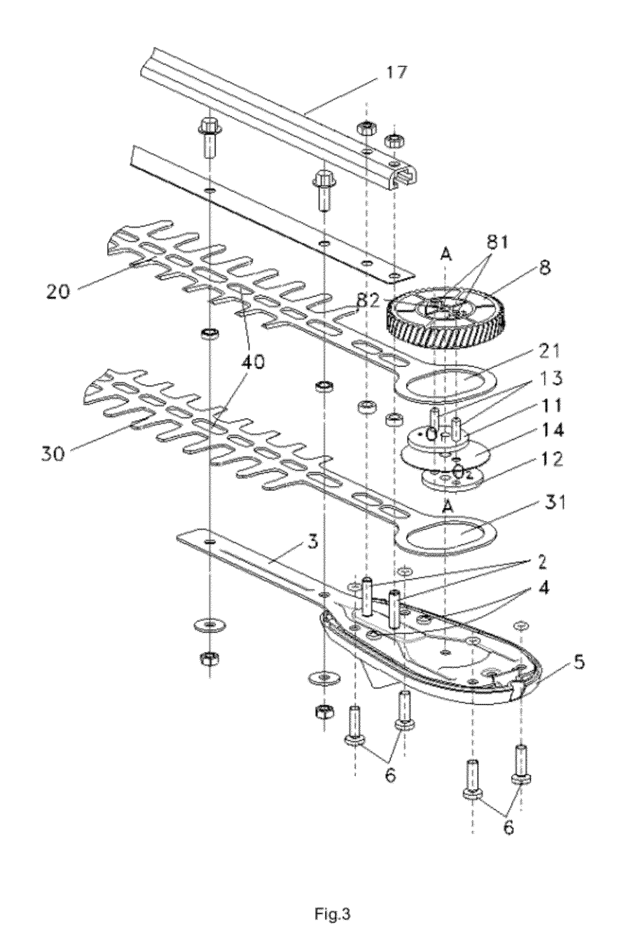

FIG. 3 illustrates an exploded view of the work head. The blade assembly 1 comprises a first blade 20 and a second blade 30 mounted together. The first blade 20 and the second blade 30 are provided with a plurality of mounting holes 40 in the direction of its reciprocating movement. For cutting vegetation within a longer and larger range, the blade body usually needs to have a certain length, however, it is easily bended and deformed when receiving an external force in a direction perpendicular to the blade body, so that the cutting efficiency is reduced. In order to enhance the bending strength of the blade body, the blade in the present embodiment is provided with a reinforcement member 17 in the length direction of the blade. Preferably, the reinforcement member 17 is a half I-shaped frame. Mounting blots pass through the round holes arranged on the reinforcement member 17 and the mounting holes 40 arranged on the first blade 20 and the second blade 30 to assemble the components together. The connection ends of the first blade 20 and the second blade 30 are respectively provided with a first slotted hole 21 and a second slotted hole 31. A first eccentric block 11 and a second eccentric block 12 respectively mate with the first slotted hole 21 and the second slotted hole 31. The eccentric blocks 11 and 12 are fixedly connected to the second gear 8 by an interference fit with pins 13. Two pins 13 are respectively fit by press in pinholes 81 on the second gear 8. The pinholes 81 are symmetrically arranged on both sides of an axis hole 82 in which the mandrel 10 is mounted. The circle center O₁ of the first eccentric block 11 and the circle center O₂ of the second eccentric block 12 are symmetrically arranged on both sides of the axis A-A of the second gear 8. The slotted holes 21 and 31 respectively have two parallel long sides, and the outer cylindrical surfaces of the eccentric blocks 11 and 12 respectively mate with the inner surfaces of the slotted holes 21 and 31 at the position where the two long sides locate. It can thus be easily understood that the blades 20 and 30 can reciprocate only in the direction perpendicular to the long sides of the slotted holes 21 and 31 when the rotary output of the second gear 8 drives the first and the second blades 20 and 30 to move via the first and the second eccentric blocks 11 and 12, because the slotted holes 21 and 31 respectively have a length greater than the diameter of the eccentric blocks 11 and 12.

A stop plate 14 is arranged between the first eccentric block 11 and the second eccentric block 12 for preventing the eccentric blocks 11 and 12 from leaping up and down along the direction of the axis A-A in the first slotted hole 21 and the second slotted hole 31. The axis of the stop plate 14 coincides with the axis A-A of the second gear, the pins 13 pass through the round holes on the stop plate 14, and the diameter of the stop plate 14 is greater than that of the eccentric blocks 11 and 12, thus the second gear 8 can be replaced with the blade assembly 1 as a whole when replacing the blades. Certainly, the member for limiting position is not limited to the above stop plate and can be a member with other shapes, as long as the stop member is ensured to have the size which the first slotted hole 21 and the second slotted hole 31 can not pass through at any time particularly when the first slotted hole 21 coincides with the second slotted hole 31.

It will also be understood that the transmission mechanism need not be limited to the form of the above transmission chain. Other forms of a transmission chain known by a person skilled in the art also could be used and, thus, belong to the protection scope of the present invention as long as the transmission chain can ultimately achieve the eccentrically rotary output. The work head of the present invention also can be connected and fixed onto the main body by replacing the fastener with a quickly-locking mechanism such as a buckle and the like.

The method for mounting blades of the hand-held power tool for pruning and cutting vegetation according to the present invention, comprising the following steps:
1) mounting the second gear to the mandrel detachably and engaging the first gear; and
2) fixedly connecting the work head to the main body.

The disassembling steps of the blade are contrary to the above mounting steps.

While various concepts have been described in detail, it will be appreciated by those skilled in the art that modifications and alternatives to those concepts could be developed in light of the overall teachings of the disclosure. Accordingly, it will be appreciated that the particular concepts disclosed are meant to be illustrative only and not limiting as to the scope of the invention which is to be given the full breadth of the appended claims and any equivalents thereof.

What is claimed is:

1. A hand-held power tool for pruning and cutting vegetation, comprising a main body and a work head detachably mounted on the main body, wherein the main body comprises a housing, a motor placed in the housing and a first gear transmissively connected with the motor and wherein the work head comprises a blade assembly and a second gear and the second gear engages with the first gear.

2. The hand-held power tool for pruning and cutting vegetation according to claim 1, wherein the second gear is provided with an eccentric member connected with the blade assembly.

3. The hand-held power tool for pruning and cutting vegetation according to claim 1, wherein the second gear is detachably mounted on a mandrel on the main body.

4. The hand-held power tool for pruning and cutting vegetation according to claim 1, wherein the eccentric member comprises a first eccentric block and a second eccentric block sequentially connected to the second gear, and the blade assembly comprises a first blade and a second blade, the first eccentric block being mated within a first slotted hole on the first blade and the second eccentric block being mated within a second slotted hole of the second blade, a stop plate being arranged between the first eccentric block and the second eccentric block and having a diameter grater than the diameter of the first eccentric block.

5. The hand-held power tool for pruning and cutting vegetation according to claim 4, wherein a center of the first eccentric block and a center of the second eccentric block are symmetrically arranged on both sides of an axis of the second gear.

6. The hand-held power tool for pruning and cutting vegetation according to claim 1, wherein the work head further comprises a bottom plate and a support plate fixedly connected with the bottom plate with the blade assembly being movably connected to the support plate.

7. The hand-held power tool for pruning and cutting vegetation according to claim 6, wherein the blade assembly is coupled to a reinforcement member.

8. A method for replacing blades of a hand-held power tool for pruning and cutting vegetation having a main body comprised of a housing, a motor arranged in the housing, a mandrel, and a first gear transmissively connected with the motor and a work head comprises of a blade assembly and a second gear, the method comprising the steps of:
detachably mounting the second gear onto the mandrel and engaging the second gear with the first gear; and
fixedly connecting the work head to the main body.

9. The method for replacing blades of a hand-held power tool for pruning and cutting vegetation according to claim 8, wherein the second gear is sequentially connected with a first eccentric block, a stop plate and a second eccentric block, wherein the first eccentric block and the second eccentric block are respectively mated with the first blade and the second blade of the blade assembly, and the stop plate is arranged between the first blade and the second blade.
